(19) United States
(12) Patent Application Publication
(10) Pub. No.: US 2026/0267872 A1
(43) Pub. Date: Sep. 10, 2026

(54) SYSTEMS AND METHODS FOR PERFORMING A STRUCTURED DATA QUERY

(71) Applicant: Kenvue Brands LLC, Summit, NJ (US)

(72) Inventors: Yogesh Tak, Jodhpur (IN); Phillip Warwick Every-Burns, Lilyfield (AU); Issac Mathew, Bengaluru (IN); Biswajit Pal, Bengaluru (IN); Ankit Parihar, Bengaluru (IN)

(21) Appl. No.: 19/545,324

(22) Filed: Feb. 20, 2026

Related U.S. Application Data
(60) Provisional application No. 63/769,298, filed on Mar. 10, 2025.

(51) Int. Cl. G06F 16/25; G06F 16/2455

(52) U.S. Cl. CPC G06F 16/258; G06F 16/2455

(57) ABSTRACT

Systems and methods for executing a structured data query according to an example. The method includes receiving a query, performing a query analysis that determines a type of the query, based on the query analysis, routing the received query to a query analyzer associated with the determined type of query, evaluating, by the query analyzer, the received query, generating a response to the received query, and outputting the generated response to the query.

### CROSS REFERENCE TO RELATED APPLICATION

This application claims the benefit of U.S. Provisional Application No. 63/769,298 filed Mar. 10, 2025, the contents of which is incorporated herein by reference in its entirety.

### BACKGROUND

Recent advancements in artificial intelligence (AI), and particularly Large Language Models (LLMs), have opened new ways to boost productivity and automate tasks. While LLMs excel at analyzing unstructured data, e.g., PDFs, Microsoft™ Word documents, etc., LLMs struggle more with understanding structured data and identifying relationships in tabular data. Reasoning over tabular data is a challenge for LLMs due to complexity of relationships between tables, rows and columns. Traditional methods of addressing these challenges remain prone to spelling errors, misunderstanding business terminology, making misinterpretations, misunderstanding industry rules, and generating hallucinations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various implementations of the present disclosure described herein are directed to systems and methods that execute a structured data query. In one implementation, a computer-implemented method is provided. The computer-implemented method comprises receiving, by a query analyzer, a query; executing the query analyzer to perform a query analysis that determines a type of the query; based on the query analysis, executing a query router to route the received query to a query analyzer associated with the determined type of query; evaluating, by a query evaluator, the routed query; generating, by a query response generator, a response to the routed query; and outputting, by a response outputter, the generated response to the routed query.

In another implementation, a system is provided. The system includes a memory and a processor coupled to the memory. The processor is configured to control to receive a query; execute a query analyzer to execute a query analysis to determine a type of the query, wherein executing the query analysis further comprises one or more of performing an ambiguity check of the received query, rewriting the query, and reviewing chat history associated with the received query; based on the query analysis, implement a query router to route the received query to a query analyzer associated with the determined type of query; evaluate, by the query analyzer, the received query, wherein the query evaluator includes one or more of a factual query analyzer, a reasoning query analyzer, and a visualization analyzer; execute a response generator to generate a response to the received query; and output the generated response to the query.

In another implementation, one or more computer-readable media is provided. The one or more computer-readable media stores instructions that, when executed by a processor, cause the processor to control to receive a query; execute a query analyzer to execute a query analysis to determine a type of query, wherein the query analyzer is further configured to execute one or more of a vector database or convert a query to structured query language (SQL) code; based on the query analysis, implement a query router to route the received query to a query analyzer associated with the determined type of query; evaluate, by a query evaluator, the received query, wherein the query evaluator includes one or more of a factual query analyzer, a reasoning query analyzer, and a visualization analyzer; execute a response generator to generate a response to the received query; and output the generated response to the query.

### BRIEF DESCRIPTION OF THE DRAWINGS

The present description will be better understood from the following detailed description read in light of the accompanying drawings, wherein:

FIG. 1 illustrates an example system for performing a structured data query according to an example;

FIG. 2 illustrates a computer-implemented method of a query analysis process according to an example;

FIG. 3 illustrates a computer-implemented method of an approach for converting structured data to text according to an example;

FIG. 4 illustrates an example system for converting a query to standard query language (SQL);

FIG. 5 illustrates an example system for evaluating reasoning questions;

FIG. 6 illustrates an example interface presenting a visualization and a response to a query;

FIG. 7 illustrates an example flowchart for performing a structured data query; and

FIG. 8 is a block diagram illustrating an example computing environment suitable for implementing one or more of the various examples disclosed herein.

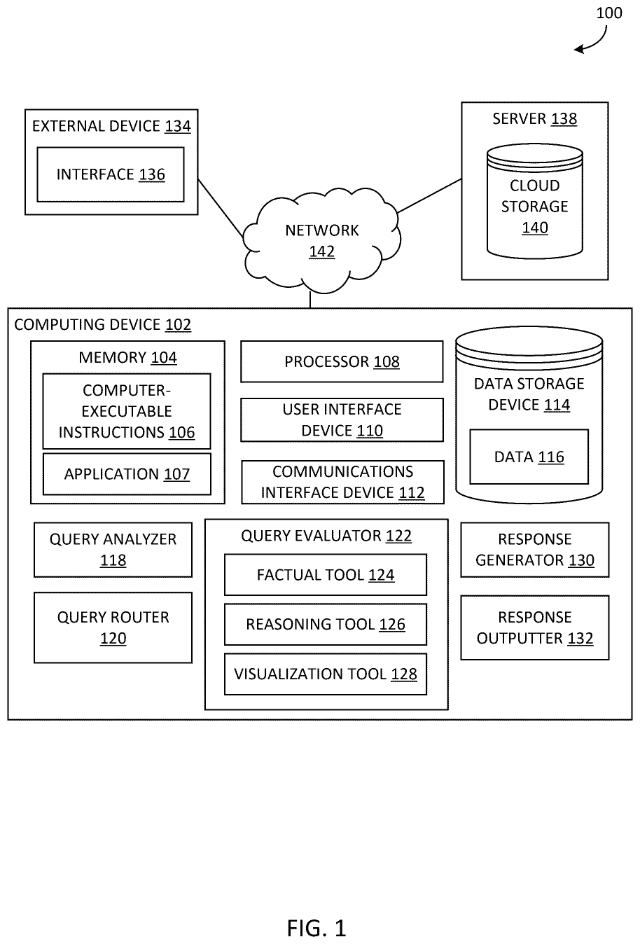

Corresponding reference characters indicate corresponding parts throughout the drawings. In FIGS. 1 to 8, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As referenced herein, current methods of implementing LLMs for understanding structured data and identifying relationships in tabular data is made difficult due to the proclivity of LLMs to make spelling errors, misunderstand business terminology, make misinterpretations, misunderstand industry rules, generate hallucinations, and so forth. The systems and methods presented herein recognize and take into account these challenges by providing an improved system that includes multiple different types of LLMs that work in combination to break down a query into separate sub-tasks that identify the intent of the query, route the query to a corresponding LLM for analysis, perform the analysis, and ultimately provide a response to the query.

The systems and methods operate in an unconventional manner by identifying a task based on a received query, generating sub-tasks for the identified task, executing each sub-tasks using a separate, specialized LLM, and generating an overarching response based on the execution of each sub-task. Accordingly, the systems and methods of the present disclosure provide a technical solution to the inherently technical problem of providing a response to a structured data query using LLMs by providing a mechanism through which data associated with a query is processed and stored in a specialized data structure to facilitate retrieval and sub-tasks are identified and executed, which in turn increases efficiency and reduces computing resources of performing the query while also providing an accurate and precise response to the query. In some examples, the LLMs are implemented as modular building blocks, increasing the scalability of the system as well as improving the ability to add additional databases to the system.

In some examples, the system receives an input, for example in the form of a question. The system identifies the intent of the intent of the question, i.e., a question to be solved or answered, and routes the question to a relevant manager agent. The manager agent further breaks the input down and assigns specific tasks to sub-agents, and ultimately summarize the finding to provide, as an output, a response. In some examples, a visualization is included as the response or included in addition to a response.

Questions may be identified as either a factual question, a reasoning question, or a visualization question. A factual question is a question asking for specific business facts that users are looking for, for example sales key performance indicators (KPIs), growth calculations, and so forth. Factual questions may be routed to either a vector store with meta data filtering, or a custom-built SQL agent. For example, where the question is frequently asked and pre-calculated, the question is routed to the vector store, and where the question is new and unique, the question is routed to the custom-built SQL agent. A reasoning question is a question asking for reasoning or analysis. Reasoning questions are handled using multiple frameworks created that are specific to a particular industry and the domain of the use case. In some examples, the particular industry is the consumer packaged goods (CPG) industry. The manager agent analyzes the question and, using inductive reasoning, creates multiple hypotheses. The manager agent then uses the SQL agent tools and pre-built frameworks to test these hypotheses. Examples of hypotheses may include, but are not limited to, brand analysis, category analysis, competitor analysis, price and promotion analysis, market growth analysis, white space analysis, strategy recommendation analysis, and optimization analysis. A visualization question is a question requesting a visualization of data related to a hypothesis. In some examples, visualization questions are first handled by the custom SQL agent to query the relevant data and then passed to another agent, such as a python agent, to generate visuals from the data. In some examples, one or more of the questions are evaluated using an evaluation strategy where the system implements a LLM to paraphrase the question and execute it multiple times, such as three times. All the generated answers are analyzed again by the LLM to generate a confidence level for the answer, which may be output along with the response.

Accordingly, the systems and methods described herein provide modular building blocks that enable efficient scaling. The systems of the present disclosure receives input like user persona, business rules, industry terminology, data hierarchy and some gold standard code examples, which enables data accessibility to be unlocked at the enterprise level and hypotheses to be tested rapidly.

FIG. 1 illustrates an example system for performing a structured data query according to an example. The system 100 illustrated in FIG. 1 is provided for illustration only. Other examples of the system 100 may be used without departing from the scope of the present disclosure. In some examples, the system 100 profiles sustainability of an innovation in order to recommend and trigger product design changes to increase the sustainability of the innovation according to one or more examples described herein.

The system 100 includes a computing device 102, an external device 134, a server 134, and a network 142. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 may also include less-portable devices such as servers, desktop personal computers, kiosks, or tabletop devices. Additionally, the computing device 102 may represent a group of processing units or other computing devices.

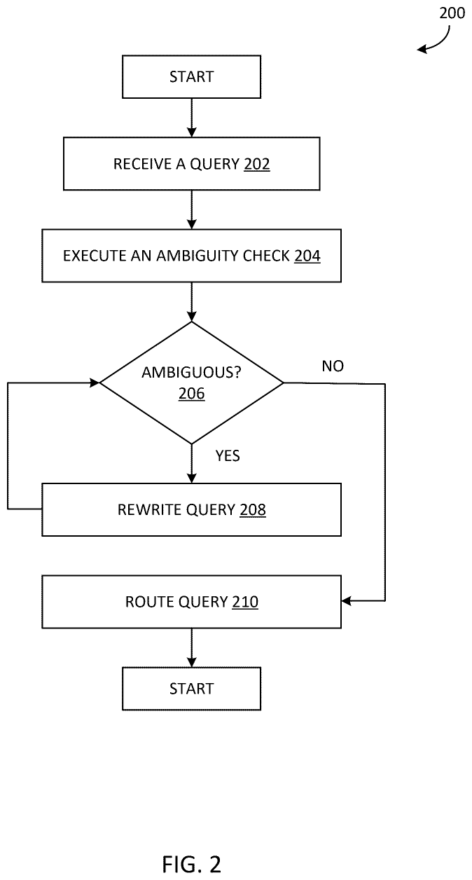

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIGS. 2-7.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 may include both a memory component internal to the computing device 102 and a memory component external to the computing device 102, such as a server 138. The memory 104 stores data, such as one or more applications 107. The applications 107, when executed by the processor 108, operate to perform various functions on the computing device 102. The applications 107 may communicate with counterpart applications or services, such as web services accessible via the network 142. In an example, the applications 107 represent server-side services of an application executing in a cloud, such as a cloud server 138.

The user interface device 110 includes a graphics card for displaying data to a user and receiving data from the user. The user interface device 110 may also include computer-executable instructions, for example a driver, for operating the graphics card. Further, the user interface device 110 may include a display, for example a touch screen display or natural user interface, and/or computer-executable instructions, for example a driver, for operating the display. The user interface device 110 may also include one or more of the following to provide data to the user or receive data from the user: speakers, a sound card, a camera, a microphone, a vibration motor, one or more accelerometers, a BLUETOOTH® communication module, global positioning system (GPS) hardware, and a photoreceptive light sensor.

The computing device 102 further includes a communications interface device 112. The communications interface device 112 includes a network interface card and/or computer-executable instructions, such as a driver, for operating the network interface card. Communication between the computing device 102 and other devices, such as but not limited to the external device 134 and/or the server 138, may occur using any protocol or mechanism over any wired or wireless connection.

The computing device 102 further includes a data storage device 114 for storing data 116. The data 116 includes, but is not limited to, a vector database, data associated with the query to SQL process described herein, and so forth. The data 116 may be provided as structured or unstructured data. In various examples, the data 116 includes raw data received prior to pre-processing, pre-processed raw data that includes data associated with one or more of year, brand, SKU, sales, price, correlated price vs. sales, and correlated sales vs. promotions, query history including previous queries, responses, and response generation process, chat history, previously generated visualizations, and so forth. In some examples, the data 116 is stored in a specialized data structure generated and stored to store pre-processed data, received initially as raw unstructured data, as structured data. The pre-processed data in the specialized data structure is stored in one or more rows of structured data in order to facilitate retrieval by a query router 120, query evaluator 122, and/or response generator 130. In some examples, a cloud-based version of the data storage device 114 is implemented on the server 138 as an example of cloud storage 140. The cloud storage 140 may store some or all of the same data 116 stored on the data storage device 114 and in the same format as on the data storage device 114.

The computing device 102 further includes a query analyzer 118, a query router 120, a query evaluator 122, a response generator 130, and a response outputter 132. Each of the query analyzer 118, query router 120, query evaluator 122, response generator 130, and response outputter 132 are examples of specialized processing units executed on the processor 108. Upon a query being received, either via an input received on the user interface device 110 or via an input received on the interface 136 and subsequently transmitted to the communications interface device 112, the query analyzer 118 performs a query analysis to determine at type of query. In some examples, the type of query is either a factual query, a reasoning query, or a visualization query. A factual query refers to a query for factual information, such as business facts, where a response includes retrieving and presenting the factual information. Various examples include sales KPIs, growth calculations, and so forth. A reasoning query refers to a query that requires reasoning to respond, rather than merely retrieving and presenting the factual information. Reasoning queries are answered using multiple frameworks, bespoke to a particular industry executing the computing device 102, and the domain of the use case. For example, the question is analyzed and, using inductive reasoning, multiple hypotheses are created. The SQL agent tools and pre-built frameworks are then implemented to test these hypotheses including, but not limited to, brand analysis, category analysis, competitor analysis, price and promotion analysis, market growth analysis, white space analysis, strategy recommendation analysis, and optimization analysis. A visualization query refers to a query that requests a visualization, in the form of a graph, chart, and so forth, of factual information, and in some examples requires reasoning to generate. A response to a visualization query is generated by a custom SQL agent to query relevant data and then pass the relevant data to an agent, such as a python agent, to generate a visualization of the data.

The query router 120 routes the analyzed query to a particular tool of the query evaluator 122. In particular, the query router 120 determines the intent of the analyzed query to determine whether the query is best answered using a factual tool 124, a reasoning tool 126, or a visualization tool 128, or a combination of these.

The query evaluator 122 includes the factual tool 124, the reasoning tool 126, and the visualization tool 128 as referenced herein. The factual tool 124 executes factual-based queries, such as sales KPIs, growth calculations, and so forth. The reasoning tool 126 executes reasoning-based queries, where the question is analyzed and, using inductive reasoning, multiple hypotheses are created. For example, the reasoning tool 126 may include performing at least one of a brand analysis, a category analysis, a market analysis, a competitor analysis, and a price and promotion analysis. The visualization tool 128 executes visualization-based queries, for example queries to visualize data in a particular type of way. In some examples, the visualization tool 128 includes an agent operating in Python to generate a visualization from the queried data 116 stored in the specialized data structure of the data storage device 114.

In some examples, the factual tool 124 executes one or both of a vector database or converting a query to structured query language (SQL) code. In examples where the vector database is executed, the factual tool 124 pre-processes raw data extracted from the query, stores the pre-processed raw data into a specialized data structure in the data storage device 114 that includes one or more rows of pre-processed raw data, converts each of the one or more rows of the pre-processed raw data into a sentence, converts each sentence into a vector, and stores each vector in the vector database. In some examples, upon receiving an additional query, the factual tool 124 executes retrieval augmented generation (RAG) context-based retrieval to retrieve the stored vector corresponding to the received additional query, and converts the retrieved vector into the generated response to the received query. In examples where the query is converted to SQL code, the factual tool 124 identifies a gold standard code based on the received query, retrieves the identified gold standard code, implements semantic similarity to retrieve proper names or attribute names in the retrieved gold standard code, and based on the retrieved proper names or attributes names, generates the SQL code.

In some examples, each of the factual tool 124, the reasoning tool 126 and the visualization tool 128 include multiple LLMs and a comparison tool to compare similarities of answers received from each LLM. For example, each LLM paraphrases a received query into multiple new questions, each of which has a response generated using the same methodology. Once multiple answers are received, the respective comparison tool compares the answers for the generated responses. Where the similarity between responses is greater than a similarity threshold, such as eighty percent, ninety percent, ninety-five percent, or similar, the response is output to the user. Accordingly, the present disclosure provides a measure of confidence in the response generated, guards against potential hallucinations, and improves user experience and response credibility.

The response generator 130 generates a response based on the evaluation by one or more of the factual tool 124, reasoning tool 126, or visualization tool 128. The generated response may be presented in the form of a textual response, a visualization such as an image, a graph, or similar, or a combination of these. For example, the response generator 130 incorporates responses generated by one or more of the factual tool 124, reasoning tool 126, and visualization tool 128 to generate a comprehensive response to the received query.

The computing device 102 further includes a response outputter 132 that outputs the generated response that is generated by the response generator 130. In some examples, the response outputter 132 outputs the response via controlling the user interface device 110 to present the generated response. In other examples, the response outputter 132 outputs the response to an external device, such as the external device 134, via the communications interface device 112. Following the response being output to the external device 134, the response may be presented on an interface 136 of the external device 134.

The external device 134 is another example of a computing device, separate from and external of the computing device 102. In some examples, the external device 134 includes a mobile computing device or any other portable device. A mobile computing device includes, for example but without limitation, a mobile telephone, laptop, tablet, computing pad, netbook, gaming device, and/or portable media player. The external device 134 can also include less-portable devices such as servers, desktop personal computers, kiosks, or tabletop devices. Additionally, the external device 134 can represent a group of processing units or other computing devices. The external device 134 includes an interface 136. The interface 136 may be another example of the user interface device 110.

FIG. 2 illustrates a computer-implemented method of a query analysis process according to an example. The computer-implemented method 200 is presented for illustration only and should not be construed as limiting. Other examples of the computer-implemented method 200 can be used without departing from the scope of the present disclosure. The computer-Company Confidential implemented method 200 can be implemented by one or more electronic devices described herein, such as the computing device 102.

The computer-implemented method 200 begins by the query analyzer 118 receiving a query in operation 202. In some examples, the query is received via the user interface device 110. In some examples, the query is received via the communications interface device 112 from the external device 134, which receives the query via the interface 136. In some examples, the received query is received during the course of a user session that includes a chat history. In other words, the query is received as a segment of a back and forth that includes multiple queries and responses, personalizing the chat experience using history.

In operation 204, the query analyzer 118 performs an ambiguity check. For example, an ambiguous question may be asked by the user and received by the query analyzer 118. The query analyzer 118 performs an analysis based on one or more of the chat history, geographic location of user's system, and latest data available. Based on the performed ambiguity check, in operation 206, the query analyzer 118 determines whether or not the received query is ambiguous. In examples where the query is determined to be ambiguous, in order to remove the ambiguity using query transformation, the computer-implemented method 200 proceeds to operation 208 and rewrites the query. In other words, the query analyzer 118 transforms the prompt or question to remove ambiguity and enable one or more LLMs to perform meta data filtering in a vector database. The first step is to check if any expected attributes are missing in the question. If so, the chat history is analyzed and those attributes are filled based on the chat history for a smooth conversation flow for the user. In examples where there are still missing attributes, the query analyzer 118 may perform one or more additional actions. For example, where an attribute, such as the time period, is ambiguous, the query analyzer 118 may default to the most recent data. In some examples, queries and responses are saved in a database in the data storage device 114 for each user session as an example of the data 116. This maintains history for individual users and is used for inferring missing parts of a question to make it less ambiguous. In some examples, the query analyzer 118 includes a query rewriter to rewrite ambiguous queries.

An example of an ambiguous query may be “what is the sales of Brand X?” This query is ambiguous due to the time period and region each missing from the query. This example of an ambiguous query may be transformed to “what is Brand X sales in India in 2024” based on the time period being retrieved from the latest data available and the India region being taken from the chat history or the user's geographic location.

In examples where the query is determined not to be ambiguous in operation 206, the computer-implemented method 200 proceeds to operation 210 where the query router 120 routes the query to the query evaluator 122. Following operation 210, the computer-implemented method 200 terminates.

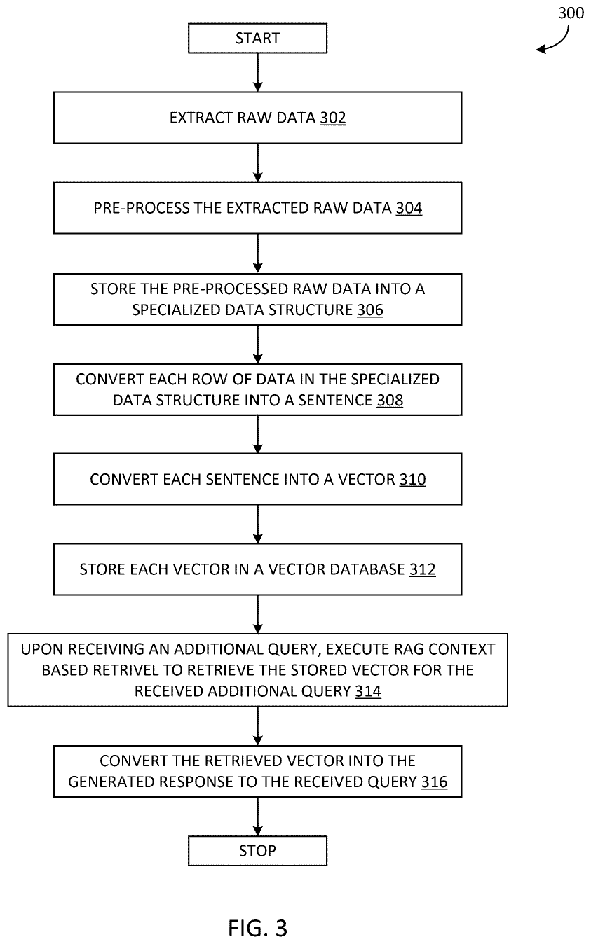

FIG. 3 illustrates a computer-implemented method of an approach for converting structured data to text according to an example. The computer-implemented method 300 is presented for illustration only and should not be construed as limiting. Other examples of the computer-implemented method 300 can be used without departing from the scope of the present disclosure. The computer-implemented method 300 can be implemented by one or more electronic devices described herein, such as the computing device 102.

As referenced herein, the query router 120 identifies factual, reasoning, and visualization questions. The factual route enables a user to retrieve specific facts, such as about business key performance indicators (KPIs) through natural language. As shown in the computer-implemented method 300, the question may be routed depending on complexity and/or frequency, such as using a vector database or a query to SQL process. The vector database approach is illustrated in the computer-implemented method 300. The use of the vector database enables structured data to be converted into unstructured text and stored in the vector database with metadata. In examples where a received query includes a relatively straightforward request, the system writes a structured output to do a metadata filter on the Vector DB (database). The vector database is used to store future queries/answers with their metadata. This helps in reducing latency and increasing accuracy.

The computer-implemented method 300 begins by the factual tool 124 extracting raw data associated with a received query after the received query is routed to the factual tool 124 by the query router 120 in operation 302. In operation 304, the factual tool 124 pre-processes the extracted raw data to generate a table, and in operation 306 stores the pre-processed raw data into a specialized data structure, such as the data storage device 114. In one example, the received query is a query for sales data for a particular brand. In this example, the extracted data is various sales data and the raw data is pre-processed into, for example, a database with fields for year, brand, SKU, sales, price, correlated price vs. sales, and correlated sales vs. promotions, as shown in Table 1 below.

TABLE 1

| | | | | | Corr. | Corr. |
|---|---|---|---|---|---|---|
| | | | | | Price | Sales |
| Year | Brand | SKU | Sales | Price | vs. Sales | vs. Promo |
| 2022 | Brand A | Sunscreen | 450235 | 18 | −0.46 | 0.68 |
| 2022 | Brand A | Cleanser | 562123 | 12 | −0.8 | 0.72 |

In operation 308, the factual tool 124 converts each row into a sentence. For example, using the data structure of Table 1, a sentence may be generated as “[Brand][SKU] has a sales of [Sales] with an average item price of [Price] in [Year]. The correlation between price and sales for [Brand][SKU] for [Year] is [Corr. Price vs. Sales].” In operation 310, the factual tool 124 converts each sentence is converted to a vector stored in a vector database. In some examples, the vector database is a database stored in the data storage device data storage device 114 and the vector is an example of data 116. For example, based on the sentence generated in operation 308, an example vector includes “Brand A Sunscreen has a sales of $450,235 with an average item price of $18 in 2022. The correlation between price and sales for Brand A Sunscreen for 2022 is −0.46.”

In operation 314, upon receiving a query, the query is routed via the query router 120 to the factual tool 124 and the response generator 130 generates a response based on the vector results stored in the vector database. In some examples, the response generator 130 performs retrieval augmented generation (RAG) context-based retrieval to retrieve the corresponding vector. In an example where the received query is “What is the total sales for Brand A Sunscreen in January 2022 and how can I increase sales?”, the response generator 130 retrieves the sales data, correlated price vs. sales, and correlated sales vs. promotions.

In operation 316, the response generator 130 converts the retrieved vector into a generated response to the received query. For example, based on the stored vector, the response generator 130 generates a response that “Total sales for Brand A Sunscreen were $450,235. Sales can be increased by increasing promotions. Promotions is a highly positive correlation with sales with a correlation of 0.68.” This method provides several advantages, including spelling errors are addressed, the usage of vector databases and RAG to reduce computing resources needed, and no intermediate python or SQL is needed. Following operation 316, the computer-implemented method 300 terminates.

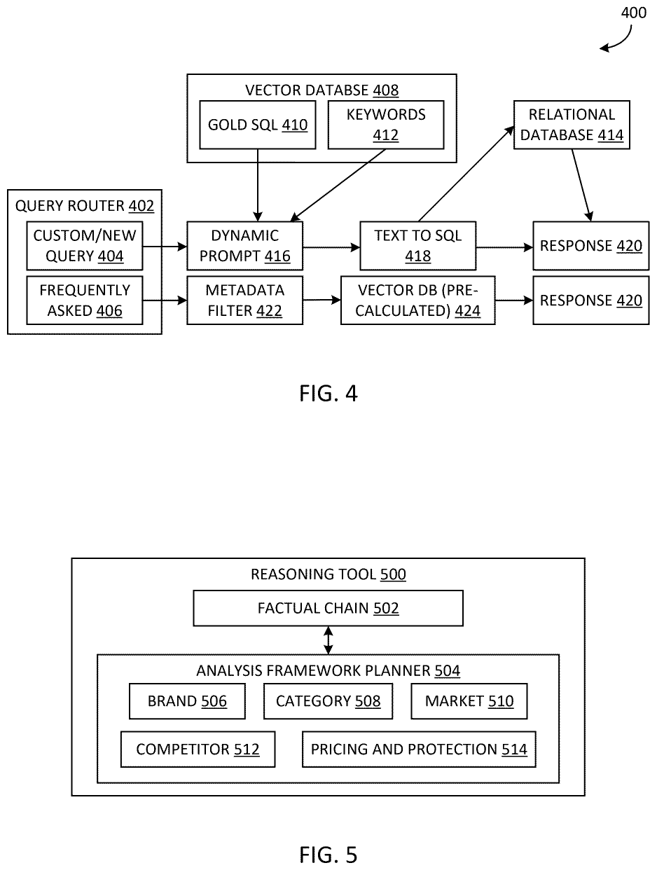

FIG. 4 illustrates an example system for converting a query to standard query language (SQL). The example system 400 illustrated in FIG. 4 is an example of an approach for converting a query to standard query language (SQL). It should be understood that the example illustrated in FIG. 4 is presented for illustration only and should not be construed as limiting.

The example system 400 includes a query router 402, a vector database 408, and a relational database 414. The query router 402 may be an example of the query router 120 and includes custom/new queries 404 and frequently asked queries 406. Custom or new queries, which are asked for the first time or asked infrequently, are classified as new queries 404. Queries that are repeated above a threshold number of times, or a threshold number of times within a given time period, are classified as frequently asked queries 406. The vector database 408 may be an example of the vector database generated and stored in the data storage device 114 as an example of data 116, such as described in FIG. 3 above.

As shown in FIG. 4, queries that responses to which require complex calculations or data retrieval are processed to SQL. SQL generation uses dynamic prompting to achieve higher accuracy. In examples where a custom or new query 404 is received, a dynamic prompt 416 is utilized. Dynamic prompting has two major components apart from table schema and sample data, the gold standard SQL code 410 and keyword 412 injection. The gold standard code refers to, based on semantic similarity and metadata filtering, the most relevant SQL code based on the user's question. This gold standard SQL code 410 is passed on to the prompt. This gold standard code base can be updated with new use cases and various types of questions asked by business users. This step creates a framework for the SQL query to be generated. The keyword 412 injection refers to, using semantic similarity, the system 400 retrieving proper nouns or all attribute names to generate queries with correct spellings of brand names, regions, product hierarchy, etc. Here, the system 400 customizes the generated SQL query specific to the question asked by the user. Upon the dynamic prompt 416 being generated, the text of the prompt is converted to SQL 418 and a response 420 is generated by an LLM of the response generator 130. To generate the response, the system 400 further implements the relational database 414 to ensure there are strong relationships between outcomes and causal variables, without using statistical models like regression, which require additional data.

In examples where a frequently asked query 406 is received, the respective tool of the query evaluator 122 performs a metadata filter on the vector database 424 to generate a structured output as the response 420. Accordingly, future queries and respective responses are stored with associated metadata in the data storage device 114 as examples of data 116.

FIG. 5 illustrates an example reasoning tool for evaluating reasoning questions. It should be understood that the example reasoning tool 500 illustrated in FIG. 5 is presented for illustration only and should not be construed as limiting.

The reasoning tool 500 provides an approach for evaluating reasoning questions enables a user to retrieve key drivers behind business KPI changes and test hypotheses. In some examples, the reasoning tool 500 is an example of the reasoning tool 126. The reasoning tool 500 includes a factual chain 502 and an analysis framework planner 504. The factual chain 502 utilizes multiple frameworks designed to test hypotheses. In this example, a manager agent analyzes the question and creates a few hypotheses which can be tested using these frameworks. In examples where new frameworks are needed, new frameworks may be added to ensure there are strong relationships between outcomes and causal variables, without using statistical models like regression, which need more data.

This approach 500 utilizes the collective wisdom of domain experts to understand relationships, which the system uses in its answers. Each framework can use tools like Vector DB retriever or SQL code agent to come up with an answer. Various examples of these frameworks include, but are not limited to, brand 506 analysis, category 508 analysis, market 510 analysis, competitor 512 analysis, and price and promotion 514 analysis. Brand analysis refers to brand level data like sales growth, volume change, analyze sub-brands, and so forth to respond to the user query. Category analysis refers to analyzing to find contribution growth at each level of granularity. In this example, a Text2SQL agent may be used here to get contribution growth numbers. Market analysis refers to querying market-level data for a given brand to determine market share, market overall growth, distribution points, etc. This data is then analyzed to determine how the brand is performing. Competitor analysis refers to querying competitor sales change, promo activity, price change, and so forth to benchmark against competitors. In some examples, a factual chain agent with a SQL approach is used for querying data. Price and promotion analysis refers to utilizing internal data to determine price growth and promotion change for each hierarchy. Each of these agentic frameworks use business knowledge and thresholds to reason and come up with final answer that is output as a response to the received query.

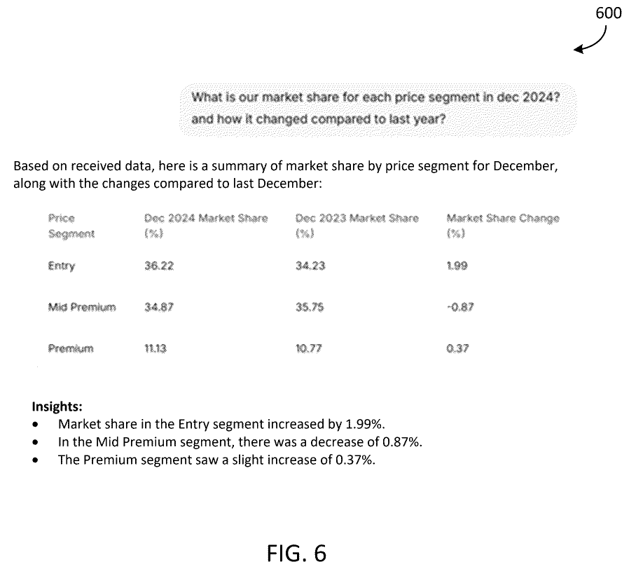

FIG. 6 illustrates an example of an interface presenting a visualization and a response to a query. The example of the interface 600 illustrated in FIG. 6 is presented for illustration only and should not be construed as limiting.

In various example, the system generates a visualization representing the response to the query to enable a user to visualize the response. In some examples, generating the visualization utilizes a factual agent framework to query the data and then a python agent to generate the visualization using libraries, for example matplotlib. In some examples, it may be difficult to evaluate structured answers using LLMs because LLMs have difficulty understanding the relationships between the numbers and/or what the numbers represent. Thus, when a query is received, the system employs an LLM to paraphrase the received query into multiple new questions and runs each new question through parallel chains that follow the same methodology. Once each answer is determined, the LLM(s) compare the similarity between the answers. If the similarity is greater than a threshold, the response is presented as an output. If not, the response is not presented and the user is asked to re-phrase the question. In other words, where the similarity is low, depending on the user preference and use case, the user is asked to clarify the question for improved analysis. This gives a measure of confidence in the answer and guards against hallucinations, as well as improves the credibility of the answer and the overall user experience.

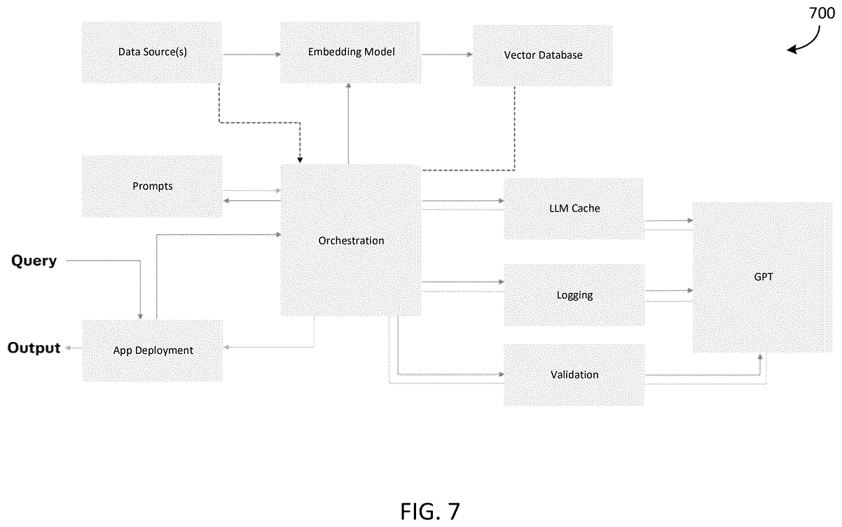

FIG. 7 illustrates an example computer-implemented method for performing a structured data query. The example method 700 illustrated in FIG. 7 is presented for illustration only and should not be construed as limiting. Various examples of the method 700 may be used without departing from the scope of the present disclosure.

As illustrated in FIG. 7, data from one or more data sources, including but not limited to internal sales data, inventory data, marketing data, and external market data that includes market share, competitor sales, pricing, distribution, and so forth, is input into an embedding model to convert the data into one or more vectors stored in a vector database. Vectors represent each keyword into a multi-dimensional space to convert the words into numbers. This enables semantic matching with keywords by finding the distance between two vectors in multi-dimension space. For example, if an input request includes “Netrogena”, the system identifies the closest keyword in the space, which will be “Neutrogena”.

In some examples, prompts are stored in a prompt database. Stored prompts include, but are not limited to, example questions, business rules, glossary, etc. The system determines which prompt to use for a particular task.

In some examples, the system is deployed on a front-end framework that matches a particular brand identify, use chat history, authentication, data access, personas, and so forth. The system further includes an LLM cache, which implements a custom-built SQLite database to cache prompts and questions. This reduces latency and cost for the system, as well as reduces computing resources needed to analyze, evaluate, and respond to prompts.

In some examples, the system further includes a logging, or tracking, module, or framework, to log each received question as an input, each process conducted of the system, costs, latency, models implemented to respond to each input, and so forth.

In some examples, the system further includes a validation module that implements one or more guardrails to avoid processing particular types of information. Various examples of information to be avoided includes, but is not limited to, personally identifiable information (PII), unwanted information or keywords, or anything determined to be outside of the scope of the system.

In some example, the LLM cache, logging, and validation are implemented by one or more Generative Pre-trained Transformer (GPT) models. In some examples, the agentic framework described herein is orchestrated using an interface for different chains.

As referenced herein, one or more examples may be designed with a modular approach such that the technical components may be extrapolated to enable scalability to other varied use cases. This modular approach enables the solution to be scalable at the enterprise level with minimal incremental effort, while ensuring that the domain knowledge and guard-rails captured for each new use case can be done by non-technical users with plain text prompts and minimal coding changes. Through these modules, the system may replace the LLM or architecture internally independent of the domain, use cases, personas and interface.

Accordingly, various aspects of the present disclosure provides reasoning capabilities on structured data by leveraging Generative AI (GenAI) with domain-specific hypotheses. The study employs GenAI techniques, such as Retrieval-Augmented Generation (RAG) and Text-to-SQL, to obtain context and generate dynamic SQL queries that address user questions based on provided data. By implementing defined guardrails over data and customized hypotheses, improved accuracy is achieved in both logical reasoning and data precision for reasoning queries. Thus, the combination of customized hypotheses and data guardrails effectively enhances reasoning capabilities on structured data. In some examples, the system incorporates multiple hypotheses during the reasoning process and/or receives manual feedback to further improve.

### Example Operating Environment

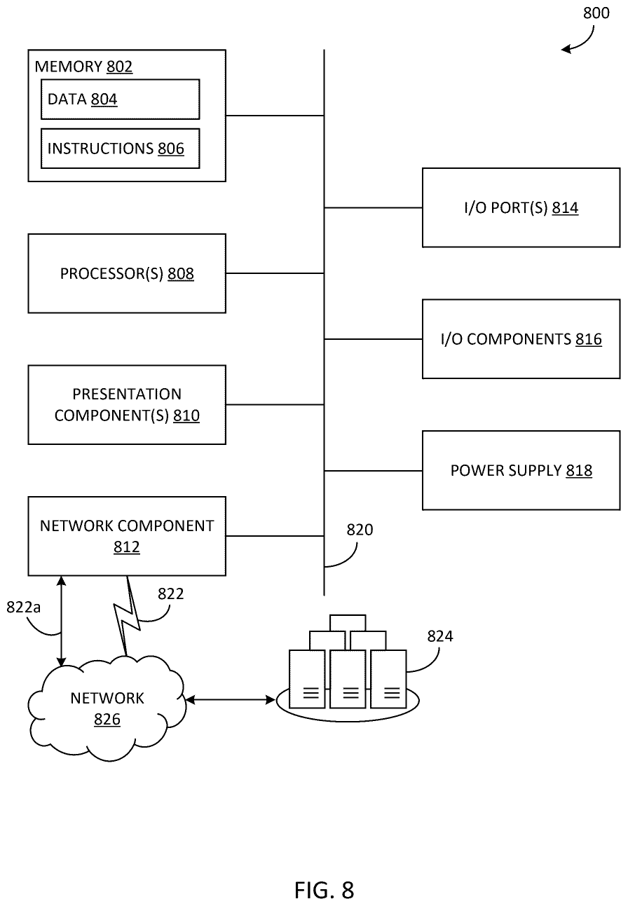

FIG. 8 is a block diagram of an example computing device 800 for implementing aspects disclosed herein and is designated generally as computing device 800. Computing device 800 is an example of a suitable computing environment and is not intended to suggest any limitation as to the scope of use or functionality of the examples disclosed herein. Neither should computing device 800 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 800 includes a bus 820 that directly or indirectly couples the following devices: computer-storage memory 802, one or more processors 808, one or more presentation components 810, I/O ports 814, I/O components 816, a power supply 818, and a network component 812. While computing device 800 is depicted as a seemingly single device, multiple computing devices 800 may work together and share the depicted device resources. For example, memory 802 may be distributed across multiple devices, and processor(s) 808 may be housed with different devices.

Bus 820 represents what may be one or more busses (such as an address bus, data bus, or a combination thereof). Although the various blocks of FIG. 8 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 8 and the references herein to a “computing device.” Memory 802 may take the form of the computer-storage media references below and operatively provide storage of computer-readable instructions, data structures, program modules and other data for computing device 800. In some examples, memory 802 stores one or more of an operating system, a universal application platform, or other program modules and program data. Memory 802 is thus able to store and access data 804 and instructions 806 that are executable by processor 808 and configured to carry out the various operations disclosed herein.

In some examples, memory 802 includes computer-storage media in the form of volatile and/or nonvolatile memory, removable or non-removable memory, data disks in virtual environments, or a combination thereof. Memory 802 may include any quantity of memory associated with or accessible by computing device 800. Memory 802 may be internal to computing device 800 (as shown in FIG. 8), external to computing device 800, or both. Examples of memory 802 include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 800. Additionally, or alternatively, memory 802 may be distributed across multiple computing devices 800, for example, in a virtualized environment in which instruction processing is carried out on multiple computing devices 800. For the purposes of this disclosure, “computer storage media,” “computer-storage memory,” “memory,” and “memory devices” are synonymous terms for computer-storage memory 802, and none of these terms include carrier waves or propagating signaling.

Processor(s) 808 may include any quantity of processing units that read data from various entities, such as memory 802 or I/O components 816 and may include CPUs and/or GPUs. Specifically, processor(s) 808 are programmed to execute computer-executable instructions for implementing aspects of the disclosure. The instructions may be performed by the processor, by multiple processors within computing device 800, or by a processor external to client computing device 800. In some examples, processor(s) 808 are programmed to execute instructions such as those illustrated in the in the accompanying drawings. Moreover, in some examples, processor(s) 808 represent an implementation of analog techniques to perform the operations described herein. For example, the operations may be performed by an analog client computing device 800 and/or a digital client computing device 800. Presentation component(s) 810 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 800, across a wired connection, or in other ways. I/O ports 814 allow computing device 800 to be logically coupled to other devices including I/O components 816, some of which may be built in. Example I/O components 816 include, for example but without limitation, a microphone, joystick, game pad, satellite dish, scanner, printer, wireless device, etc.

Computing device 800 may operate in a networked environment via network component 812 using logical connections to one or more remote computers. In some examples, network component 812 includes a network interface card and/or computer-executable instructions (e.g., a driver) for operating the network interface card. Communication between computing device 800 and other devices may occur using any protocol or mechanism over any wired or wireless connection. In some examples, network component 812 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 812 communicates over wireless communication link 822 and/or a wired communication link 822a to a cloud resource 824 across network 826. Various different examples of communication links 822 and 822a include a wireless connection, a wired connection, and/or a dedicated link, and in some examples, at least a portion is routed through the internet.

Although described in connection with an example computing device 800, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and are non-transitory, i.e., exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

In one example, a computer-implemented method is provided. The computer-implemented method comprises receiving, by a query analyzer, a query; executing the query analyzer to perform a query analysis that determines a type of the query; based on the query analysis, executing a query router to route the received query to a query analyzer associated with the determined type of query; evaluating, by a query evaluator, the routed query; generating, by a query response generator, a response to the routed query; and outputting, by a response outputter, the generated response to the routed query.

In another example, a system is provided. The system includes a memory and a processor coupled to the memory. The processor is configured to control to receive a query; execute a query analyzer to execute a query analysis to determine a type of the query, wherein executing the query analysis further comprises one or more of performing an ambiguity check of the received query, rewriting the query, and reviewing chat history associated with the received query; based on the query analysis, implement a query router to route the received query to a query analyzer associated with the determined type of query; evaluate, by the query analyzer, the received query, wherein the query evaluator includes one or more of a factual query analyzer, a reasoning query analyzer, and a visualization analyzer; execute a response generator to generate a response to the received query; and output the generated response to the query.

In another example, one or more computer-readable media is provided. The one or more computer-readable media stores instructions that, when executed by a processor, cause the processor to control to receive a query; execute a query analyzer to execute a query analysis to determine a type of query, wherein the query analyzer is further configured to execute one or more of a vector database or convert a query to structured query language (SQL) code; based on the query analysis, implement a query router to route the received query to a query analyzer associated with the determined type of query; evaluate, by a query evaluator, the received query, wherein the query evaluator includes one or more of a factual query analyzer, a reasoning query analyzer, and a visualization analyzer; execute a response generator to generate a response to the received query; and output the generated response to the query.

Further examples are described herein.

Various examples further include one or more of the following:
wherein executing the query analysis further comprises one or more of performing an ambiguity check of the received query, rewriting the query, and reviewing chat history associated with the received query;
wherein the query analyzer includes one or more of a factual query analyzer, a reasoning query analyzer, and a visualization analyzer;
wherein executing the factual query evaluator further comprises executing one or more of a vector database or converting a query to structured query language (SQL) code;
wherein executing the vector database further comprises: pre-processing raw data extracted from the query; storing the pre-processed raw data into a specialized data structure comprising one or more rows of pre-processed raw data; converting each of the one or more rows of the pre-processed raw data into a sentence; converting each sentence into a vector; and storing each vector in the vector database;
upon receiving an additional query, executing retrieval augmented generation (RAG) context-based retrieval to retrieve the stored vector corresponding to the received additional query; and converting the retrieved vector into the generated response to the received query;
wherein executing the query to SQL code further comprises: identifying a gold standard code based on the received query; retrieving the identified gold standard code; implementing semantic similarity to retrieve proper names or attribute names in the retrieved gold standard code; and based on the retrieved proper names or attributes names, generating the SQL code;
wherein executing the reasoning query evaluator further comprises performing at least one of a brand analysis, a category analysis, a market analysis, a competitor analysis, and a price and promotion analysis;
wherein to generate the response to the received query, the response generator further: generates a visualization using one or more libraries;
wherein generating the response further comprises: paraphrasing the received query into multiple new queries; generating an answer for each of the multiple new queries; and comparing similarity between the generated answer for each of the multiple new queries; and
based on the compared similarity being greater than a threshold, generating the visualization; and based on the compared similarity not being greater than the threshold, outputting a prompt that prompts an input of an updated query.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer-implemented method, comprising:
receiving, by a query analyzer, a query;
executing the query analyzer to perform a query analysis that determines a type of the query;
based on the query analysis, executing a query router to route the received query to a query analyzer associated with the determined type of query;
evaluating, by a query evaluator, the routed query;
generating, by a query response generator, a response to the routed query; and
outputting, by a response outputter, the generated response to the routed query.

2. The computer-implemented method of claim 1, wherein executing the query analysis further comprises one or more of performing an ambiguity check of the received query, rewriting the query, and reviewing chat history associated with the received query.

3. The computer-implemented method of claim 1, wherein the query evaluator includes one or more of a factual query analyzer, a reasoning query analyzer, and a visualization analyzer.

4. The computer-implemented method of claim 3, wherein executing the factual query evaluator further comprises executing one or more of a vector database or converting a query to structured query language (SQL) code.

5. The computer-implemented method of claim 4, wherein executing the vector database further comprises:
pre-processing raw data extracted from the query;
storing the pre-processed raw data into a specialized data structure comprising one or more rows of pre-processed raw data;
converting each of the one or more rows of the pre-processed raw data into a sentence;
converting each sentence into a vector; and
storing each vector in the vector database.

6. The computer-implemented method of claim 5, further comprising;
upon receiving an additional query, executing retrieval augmented generation (RAG) context-based retrieval to retrieve the stored vector corresponding to the received additional query; and
converting the retrieved vector into the generated response to the received query.

7. The computer-implemented method of claim 4, wherein executing the query to SQL code further comprises:
identifying a gold standard code based on the received query;
retrieving the identified gold standard code;
implementing semantic similarity to retrieve proper names or attribute names in the retrieved gold standard code; and
based on the retrieved proper names or attributes names, generating the SQL code.

8. The computer-implemented method of claim 3, wherein executing the reasoning query evaluator further comprises performing at least one of a brand analysis, a category analysis, a market analysis, a competitor analysis, and a price and promotion analysis.

9. The computer-implemented method of claim 1, wherein to generate the response to the received query, the response generator further:
generates a visualization using one or more libraries.

10. The computer-implemented method of claim 9, wherein generating the response further comprises:
paraphrasing the received query into multiple new queries;
generating an answer for each of the multiple new queries; and
comparing similarity between the generated answer for each of the multiple new queries.

11. The computer-implemented method of claim 10, further comprising:
based on the compared similarity being greater than a threshold, generating the visualization; and
based on the compared similarity not being greater than the threshold, outputting a prompt that prompts an input of an updated query.

12. A system, comprising:
a memory; and
a processor coupled to the memory and configured to:
control to receive a query;
execute a query analyzer to execute a query analysis to determine a type of the query, wherein executing the query analysis further comprises one or more of performing an ambiguity check of the received query, rewriting the query, and reviewing chat history associated with the received query;
based on the query analysis, implement a query router to route the received query to a query analyzer associated with the determined type of query;
evaluate, by the query analyzer, the received query, wherein the query evaluator includes one or more of a factual query analyzer, a reasoning query analyzer, and a visualization analyzer;
execute a response generator to generate a response to the received query; and
output the generated response to the query.

13. The system of claim 12, wherein the query evaluator is further configured to execute one or more of a vector database or convert a query to structured query language (SQL) code.

14. The system of claim 13, wherein, to execute the vector database, the query evaluator is further configured to:
pre-process raw data extracted from the query;
store the pre-processed raw data into a specialized data structure comprising one or more rows of pre-processed raw data;
convert each of the one or more rows of the pre-processed raw data into a sentence;
convert each sentence into a vector; and
store each vector in the vector database.

15. The system of claim 14, wherein the query analyzer is further configured to:
upon receiving an additional query, execute retrieval augmented generation (RAG) context-based retrieval to retrieve the stored vector corresponding to the received additional query; and
convert the retrieved vector into the generated response to the received query.

16. The system of claim 13, wherein, to convert the query to SQL code, the query analyzer is further configured to:
identify a gold standard code based on the received query;
retrieve the identified gold standard code;
implement semantic similarity to retrieve proper names or attribute names in the retrieved gold standard code; and
based on the retrieved proper names or attributes names, generate the SQL code.

17. The system of claim 12, wherein to generate the response to the received query, the response generator is further configured to:
implement a first agent to search data included in the received query, wherein implementing the first agent further comprises:
paraphrasing the received query into multiple new queries;
generating an answer for each of the multiple new queries; and
comparing similarity between the generated answer for each of the multiple new queries; and
implement a second agent to generate a visualization using one or more libraries.

18. The system of claim 17, wherein:
based on the compared similarity being greater than a threshold, the response generator is further configured to implement the second agent to generate the visualization; and
based on the compared similarity not being greater than the threshold, the processor is further configured to output a response prompting an input of an updated query.

19. One or more non-transitory computer readable media storing instructions that, when executed by a processor, cause the processor to:
control to receive a query;
execute a query analyzer to execute a query analysis to determine a type of query, wherein the query analyzer is further configured to execute one or more of a vector database or convert a query to structured query language (SQL) code;
based on the query analysis, implement a query router to route the received query to a query analyzer associated with the determined type of query;
evaluate, by a query evaluator, the received query, wherein the query evaluator includes one or more of a factual query analyzer, a reasoning query analyzer, and a visualization analyzer;
execute a response generator to generate a response to the received query; and
output the generated response to the query.

20. The one or more non-transitory computer readable media of claim 19, further storing instructions to generate the response to the received query that, when executed by the processor, cause the processor to:
implement a first agent to search data included in the received query, wherein implementing the first agent further comprises:
paraphrasing the received query into multiple new queries;
generating an answer for each of the multiple new queries; and
comparing similarity between the generated answer for each of the multiple new queries; and
implement a second agent to generate a visualization using one or more libraries.
